(19) United States
(12) Patent Application Publication
(10) Pub. No.: US 2024/0149080 A1
(43) Pub. Date: May 9, 2024

(54) CLEANROOM COVERALL

(71) Applicant: ALSICO HIGH TECH, Ronse (BE)

(72) Inventor: Gauthier SIAU, Elsegem (BE)

(21) Appl. No.: 18/550,389

(22) PCT Filed: Feb. 25, 2022
(86) PCT No.: PCT/EP2022/054842

§ 371 Date: Sep. 13, 2023

(30) Foreign Application Priority Data
Mar. 19, 2021 (EP) 21163832.5

(51) Int. Cl. A62B 17/00; A62B 9/00

(52) U.S. Cl. CPC A62B 17/006; A62B 9/006

(57) ABSTRACT

A cleanroom coverall includes a coverall suit and a ventilator positioned inside the coverall suit. The ventilator is fluidly connected to the ambient of the coverall, such that between the ambient of the coverall suit and the ventilator, a one-way valve is present which is situated upstream the ventilator and which one-way valve opens when the ventilator is active.

### FIELD OF THE INVENTION

The invention relates to cleanroom garments, like cleanroom coveralls, and to the use of such cleanroom garments in cleanroom environments.

### BACKGROUND OF THE INVENTION

Cleanroom garments, like cleanroom coveralls are known. Cleanroom coveralls usually also comprise a hood with integrated goggle, which hood may be attached to the rest of the cleanroom garment or worn with a shoulder part covered by the body part of the coverall. As such, the user becomes completely encapsulated by a relatively dense textile surface, covering the complete body of the user. At the inner side of the cleanroom coverall, a micro-climate environment is created. The temperature inside the garment may raise and the concentration of gasses like CO₂ and H₂O may increase gradually.

In order to keep the inside atmosphere good enough to allow comfortable activity of the user, a cleanroom coverall comprising a ventilator at the inner side of the coverall was provided by US2020/0359714. This cleanroom coverall has some disadvantages. The ventilator is provided in a longitudinal hollow body, the ventilator blowing air into the coverall via the proximal open end of the longitudinal hollow body. This proximal open end of the longitudinal hollow body may be open or closed, depending on the status of a valve installed at the proximal open end of the longitudinal hollow body. Via a surrounding air suction tube, air is sucked from the coveralls ambient into the longitudinal hollow body. The surrounding air suction tube is connected to the coverall textile by an air inlet means which is situated on the outer side of the coverall. This air inlet means is an open means, i.e. there is not necessarily a filter present between the coverall ambient and the inner side of the inlet means, once coupled between the coverall ambient and up to the one way valve. Hence contaminants present in the passageway from the ambient, passing the ventilator up to the one-way valve may form a potential contamination risk when the coverall is brought and used inside a cleanroom. This in particular if, for whatever reason, a counter airflow from the one-way valve back to the ambient is generated.

If for whatever reason the air suction tube gets disconnected from the air inlet means, an open channel is created between the inner side of the cleanroom garment and the ambient of the cleanroom garment. This is a severe risk for contaminating the cleanroom atmosphere.

### SUMMARY OF THE INVENTION

It is an object of the present invention to provide cleanroom coveralls which show a reduced risk in contaminating the ambient of the cleanroom, while the cleanroom coveralls are safe and/or comfortable to wear. The cleanroom coveralls have a well-controlled inside environment creating good and controlled working conditions for the user wearing the cleanroom coverall.

According to a first independent aspect of the invention, a cleanroom coverall is provided. The cleanroom coverall comprises a coverall suit and a ventilator positioned inside the coverall suit. The ventilator is fluidly connected to the ambient of the cleanroom coverall, such that between the ambient of the cleanroom coverall and the ventilator, a one-way valve is present. This one-way valve is situated upstream the ventilator, which one-way valve opens when the ventilator is active. The ventilator is adapted to draw air from the ambient through the one-way valve towards the inner volume of the coverall suit. The one-way valve is situated at the intake side of the ventilator. The one-way valve is always, i.e. default, in closed position, except when the ventilator becomes and is active. At that moment, the one-way valve opens and allows air to pass from the ambient via the one-way valve and the ventilator inwards the coverall suit.

A one-way valve is also known as check valve, non-return valve, reflux valve, retention valve, or foot valve.

The coverall suit is provided from textile material, which textile material is adapted for use for cleanroom garment. Typically, the textile material is a relatively dense, possibly polyester (PES), filament woven fabric being provided with antistatic properties. The textile material preferably has a surface weight in the range of 40 to 220 g/m², such as in the range of 50 to 200 g/m².

The textile material preferably meets the requirements of IEST-RP-CC003.4 and the anti-static clothing standard EN1149.

This cleanroom garment according to the first aspect of the invention has the advantage that upon interruption of the ventilator activity, upon blockage of the ventilator output or upon malfunctioning of the one-way valve, the risk on contamination flowing back to the ambient of the cleanroom coverall, is reduced or even brought to zero. As the one-way valve is situated before, upstream the ventilator, and preferably as close as possible to the coverall suit, the volume of possibly contaminated air which may flow back to the cleanroom environment, i.e. the ambient of the cleanroom coverall, is restricted.

As the one-way valve opens only upon activation of the ventilator, it means that in case of inactivity of the ventilator, either before or during use, no contaminated air can flow to the cleanroom coverall ambient. In case of a back pulse, this one-way valve will close before the back pulse pressure has passed the one-way valve, thus before it has had the opportunity to pass beyond the one-way valve towards the ambient.

According to some embodiments, the one-way valve is present in a fluid guiding means present between the ambient of the coverall suit and the intake side of the ventilator. This fluid guiding means may e.g. be a polymer tubing or alike. Alternatively, the one-way valve may be directly connected to the intake side of the ventilator.

According to some embodiments, the ventilator be coupled to the coverall suit by means of a coupling means.

The coupling means is an integrate part of the cleanroom coverall suit. The closing means can be stitched into or thermally welded onto the coverall suit and closing a hole in the coverall suit. Preferably this coupling means is provided at or near the waist or hip zone of the coverall suit. The ventilator, and optionally a fluid guiding means coupling the coupling element to the ventilator, hence is preferably worn by the user at the waist or hip region of his or her body. It may be worn by the user by clipping it to a belt or alike.

According to some embodiments, the one-way valve may be part of the coupling means. The valve may comprise a rather rigid valve body which closes one or more openings at the inflow side of the valve. The valve body may be actuated and moved by a spring pushing or pulling the valve to its closed position. Alternatively, the valve body may be made of rather flexible material, such as flexible material, e.g. polymer, rubber or silicone material, and may be moved to its closed position by its inherent shape and/or resiliency. Upon applying a pressure difference over such valve body, the valve body may deform or move such that the valve opens. When the pressure difference disappears, the valve closes again due to its inherent resilience.

According to some embodiments, the coupling means may couple to the ventilator. Alternatively, coupling means may couple to the ventilator via a fluid guiding means, which fluid guiding means is positioned between the coupling means and the intake of the ventilator.

The one-way valve being present in the coupling means which is part of the coverall suit, has the advantage that, as long as the coupling means is not coupled to the fluid guiding means present between the ambient of the coverall suit and the intake side of the ventilator, or to the intake of the ventilator itself, there is no opening in the coverall suit itself. This means that, from the moment the coverall suit is worn by the user, there is no opening anymore between the “dirty” side inside the coverall suit, and the clean side outside the coverall suit, independent whether or not the coupling is coupled to the fluid guiding means or the ventilator. The user can safely enter the cleanroom even with a coupling means uncoupled, because dirty side and clean side are not in communication with each other except through the cleanroom garment textile itself. There is no open channel between the two sides of the coverall suit, which may be problematic if the cleanroom coverall is already in use in the cleanroom itself. So, the coupling can be made, and this coupling will not create an open channel between the two sides of the coverall suit. And even in case the user forgets to make the coupling, there will not be an open channel between the two sides of the coverall suit. The cleanroom coverall according to the present invention hence provided certainty of use in cleanroom environment, even in case of mistake of the user.

Also, during use of the cleanroom coverall in the cleanroom, there is less danger to contaminate the ambient in the cleanroom in case the coupling of the coupling means to the fluid guiding means or ventilator is broken. In this situation, the one-way valve will immediately close, and the risk of contaminated air to flow back into the ambient is virtually nihil.

According to some embodiments, the coupling means may comprise a click system. Alternatively, a coupling means based upon components coupling by screwing threads and/or alike may be used.

According to a second independent aspect of the invention, a cleanroom coverall is provided, which cleanroom coverall comprises a coverall suit and a CO₂ measurement device, also referred to as CO₂ sensor, being present inside the coverall suit. The features of this second aspect can be combined with any of the cleanroom coveralls according to the first aspect of the invention.

So according to some embodiments, a CO₂ measurement device is present inside the coverall suit. Possibly, the CO₂ measurement devices or “sensor”, are based upon spectrometric principles, such as nondispersive IR sensors.

The CO₂ measurement device may be part of a measurement system, measuring, next to CO₂, also the humidity, the temperature, the oxygen content, possible CO content and/or any other relevant component in the atmosphere inside the coverall suit. Optionally, more than one measurement device per measured criterion may be provided, e.g. two or more CO₂ measurement devices.

Preferably the CO₂ measurement device, and optionally the other components of the measurement system, may be located near the chest of the user or near the neck of the user, such as near the upper part of the chest, e.g. near the left or right clavicle of the user or at the level of the thyroid gland of the user. This position was found to be most efficient and reliable to measure the content of the environment inside the coverall suit.

According to some embodiments, the CO₂ measurement device may be communicatively coupled to the ventilator, optionally through a signal controlling means. The CO₂ measurement device may be communicatively coupled to the ventilator, or signal controlling means, using a wired communication means, or wireless, e.g. by using Bluetooth or wifi-communication or alike. According to some embodiments, the CO₂ value measured by the CO₂ measurement device may be used to control the ventilation and/or ventilation speed of the ventilator. It may be used to switch on and off the ventilation.

On the one hand, and though peak values such up to 8000 ppm may occur, keeping the CO₂ level under a threshold level of 5000 ppm, is of utmost importance for creating a safe and comfortable atmosphere, or micro-climate, inside the cleanroom coverall. On the other hand, providing a too large volume of fresh air may cool the skin of the user too much, which again may cause discomfort to the user. Controlling the amount of air to be supplied, and thereby bringing these two requirements into balance, by measuring the CO₂ level and tuning the amount of air to be provided by switching and/or tuning the speed of the ventilator, gives an improved general user comfort.

In general, the flow rate of the ventilator may at maximum be 150 l/min, such as in the range of 0l/min to 150 l/min, such as in the range of 50 l/min to 150 l/min.

According to some embodiments, the cleanroom coverall may further comprise an alarm system. The alarm system may generate an alarm signal, such as a visual, tangible and/or auditive signal, when the CO₂ value measured by the CO₂ measurement device exceeds one or more threshold values.

Users of the cleanroom coverall him- or herself has no vision on the ventilator itself, nor on possible devices connected to the ventilator he or she wears under the coverall suit. In case something goes wrong with ventilator, tubing or alike, or in case the CO₂ level becomes too high due to excessive breathing, a signal needs to be generated to inform the user or other staff members, of the potential danger. As such a visual signal may be given, which is visible for other staff members in- or outside the cleanroom. Or a tangible or auditive signal may be given by means of the ventilator or the possible devices connected to the ventilator, like a noise signal and/or a vibration signal and/or alike. The generated alarm may also be transmitted to a controller which is aside or even outside the cleanroom. This controller may be provided with the signal and may warn staff members inside or outside the cleanroom of the potential danger. Alternatively, the measured CO₂ values may be transmitted to a controller positioned inside or outside the cleanroom, where the controller itself interprets the measurements and generates an alarm signal if this is needed according to the measured CO₂ values. This externally generated alarm signal may be transmitted back to the user him- or herself and made visible, audible and/or sensible to the user.

According to a third independent aspect of the invention, a cleanroom coverall is provided, which cleanroom coverall comprises a coverall suit and a ventilator inside the coverall suit, the ventilator having a noise output level less than or equal to 80 dB. The features of this third aspect can be combined with any of the cleanroom coveralls according to the first and/or second aspect of the invention.

So according to some embodiments, the ventilator may have a noise output level less than 80 dB. Optionally the ventilator may have a noise output level less than 75 dB, such as less than 70 dB, even less than 65 dB, e.g. less than 60 dB or, even less than 55 dB. Most preferred, the ventilator may have a noise output level less than 50 dB, such as less than 45 dB, even less than 40 dB, e.g. less than 30 dB or, even less than 20 dB.

Using such low noise ventilators improve the user friendliness of the cleanroom coverall. Two users, each being equipped with a cleanroom coverall, can only communicate to each other either auditive or by hand signs. This because nonverbal communication is severely restricted due to the covering of substantially the whole body of the users. Therefore, the auditive communication should not be hindered by too much noise from equipment worn close to the body. Hence it was found that a noise level of the ventilator kept under the threshold value of 80 dB, preferably less than 60 dB, most preferred less than 40 dB, such as in the range of 15 dB to 40 dB, allows regular communication between two users each wearing a cleanroom coverall according to the invention.

According to a fourth independent aspect of the invention, a cleanroom coverall is provided, which cleanroom coverall comprises a coverall suit having a hood portion and a ventilator located inside said coverall suit, the outlet side of the ventilator is coupled to a tubing system, the tubing system being adapted to bring air to the hood portion of the coverall suit. The features of this fourth aspect can be combined with any of the cleanroom coveralls according to the first and/or second and/or third aspect of the invention.

So according to some embodiments, the coverall may comprise a hood portion, the outlet side of the ventilator is coupled to a tubing system, the tubing system being adapted to bring air to the hood portion of the coverall suit. According to some embodiments, the tubing may extend into the hood portion of the coverall. The hood portion may be a separate part of the cleanroom coverall, but according to some embodiments, the cleanroom coverall may comprise an integrated hood part.

The provision of air supply from the ventilator into the hood portion of the cleanroom coverall, in particular directly near the nose, mouth and/or cheeks of the user, has as an advantage that the occurrence of steaming up the goggle, or even the creation of condensation liquid on the goggles, can be partially or completely avoided.

The cleanroom coverall may comprise a body part, itself comprising a front part and a rear part, two arm parts and a part for the pair of legs, and these combined with appropriate closing means. The cleanroom coverall may further comprise a hood part with attached shoulder part, which shoulder part extends into the body part of the coverall. Alternatively, even preferably, the coverall further comprises an integrated hood part which is attached to the body part. The hood part may comprise an integrated goggle.

According to a fifth independent aspect of the invention, a cleanroom coverall is provided, which cleanroom coverall comprises a battery and an alarm system, the alarm system generating an alarm signal, such as a visual, tangible and/or auditive signal, when the battery power goes under a threshold value. The features of this fifth aspect can be combined with any of the cleanroom coveralls according to the first and/or second and/or third and/or fourth aspect of the invention.

So according to some embodiments, the cleanroom coverall may comprise a battery and an alarm system, the alarm system generating an alarm signal, such as a visual, tangible and/or auditive signal, when the battery power goes under a threshold value.

According to a sixth independent aspect of the invention, a cleanroom coverall is provided, which cleanroom coverall comprises a coverall suit and a ventilator inside the coverall suit, said cleanroom coverall is communicatively coupled to a controller, the controller getting status information on the ventilator, and if applicable the CO₂ measurement means and/or the alarm system and/or the battery power. The features of this sixth aspect can be combined with any of the cleanroom coveralls according to the first and/or second and/or third and/or fourth and/or fifth aspect of the invention.

So according to some embodiments, the cleanroom coverall is communicatively coupled to a controller, said controller getting status information on the ventilator, and if applicable the CO₂ measurement means and/or the alarm system and/or the battery power.

The room coverall is communicatively coupled to a controller using a wired communication means, or wireless, e.g. by using Bluetooth or wifi-communication and alike. The controller may be a controller located on a control device present inside the coverall suit, or being remotely provided, such as being a part of a computer or server or alike. The controller may be aside or even outside the cleanroom.

This controller may provide a signal and may warn staff members inside or outside the cleanroom of the potential danger when properties measured and communicated to the controller on a given cleanroom coverall are outside the safe ranges. As an example, a measured CO₂ values may be transmitted to a controller positioned inside or outside the cleanroom, where the controller itself interprets the measurements and generate an alarm signal if this is needed according to the measured CO₂ values. As another example, a failing ventilator may be detected by the controller positioned inside or outside the cleanroom, or a low battery may be observed by the controller.

The generated alarm signal may be transmitted back to the user of the cleanroom coverall him- or herself and made visible, audible and/or sensible to the user.

### BRIEF DESCRIPTION OF THE DRAWINGS

FIG. 1 illustrates schematically a cleanroom coverall according to the invention.

FIG. 2 illustrates schematically another cleanroom coverall according to the invention.

FIG. 3 shows schematically a cross section of the coverall suit, coupling means and ventilator being part of the cleanroom coverall according to the invention of FIGS. 1 and 2.

FIG. 4 schematically a detail of a coupling means in a coverall suit, the coupling means being part of the cleanroom coverall according to the invention of FIGS. 1 and 2. FIG. 4 shows as well a cross section of this coupling means.

The same references refer to the same, analogue or similar features in the different figures.

### DETAILED DESCRIPTION OF EMBODIMENT(S)

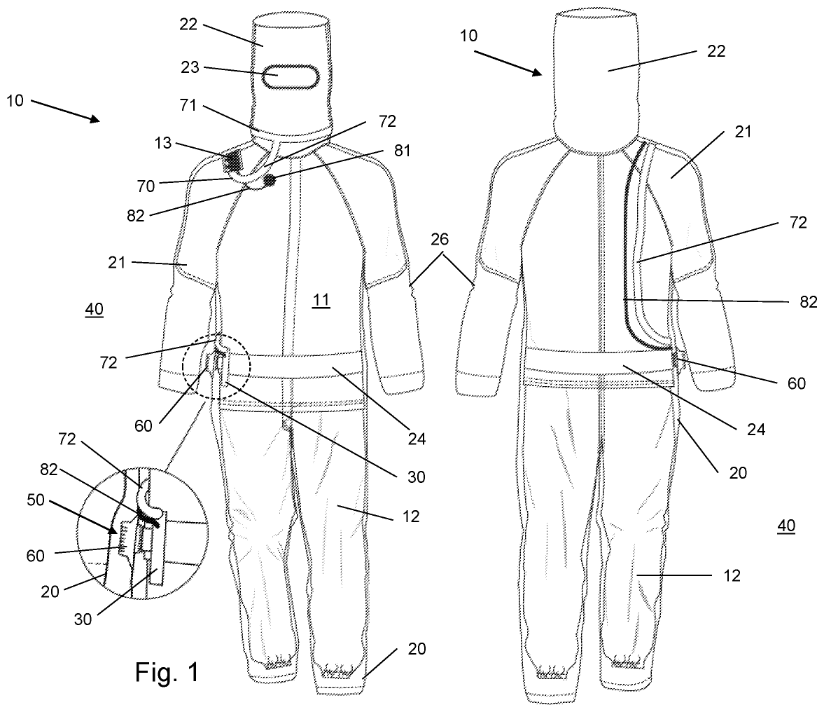

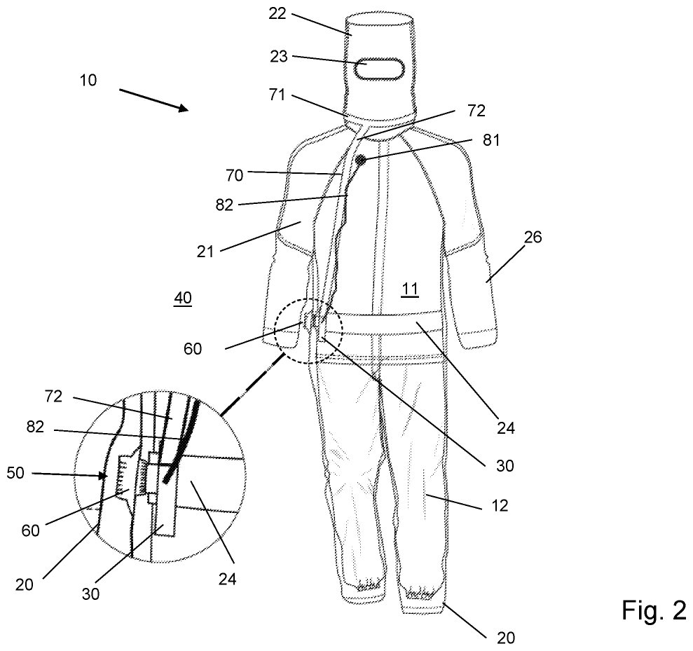

A cleanroom coverall 10 according to the invention is shown in FIGS. 1 and 2. The cleanroom coverall 10 comprises a coverall suit 20, a ventilator 30 positioned inside the coverall suit 20. The ventilator 30 is fluidly connected to the ambient 40 of the cleanroom coverall 10. Between the ambient 40 of the cleanroom coverall 10 and the ventilator 30, a one-way valve 50 is present, which one-way valve 50 opens when the ventilator 30 is active.

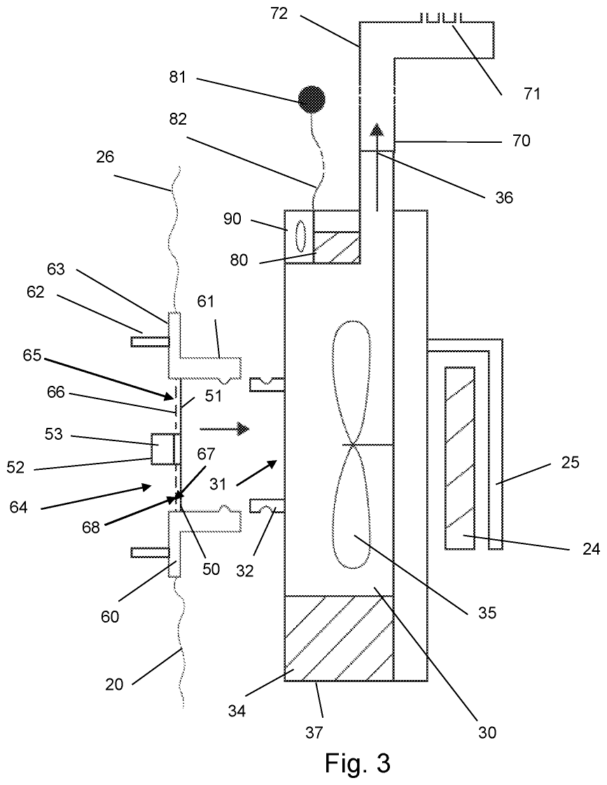

The coverall suit 20 has a body part 21 to cover the body, arms and legs of the wearer, and an integrated hood part 22, to cover the head of the user. At the front side of the coverall suit 20, a goggle 23 is provided. The ventilator 30 is worn in this embodiment at the hip of the user, either at the right side of the body as shown in FIGS. 1 and 2, or alternatively at the left side. The ventilator 30 is coupled to a belt 24, worn at hip-height of the user. The ventilator 30 is provided with a hook 25, hooking behind the belt 24, as shown in FIG. 3. The ventilator 30, once coupled to the belt, remains stable at the coupling position when the user is active, e.g. is walking and working in a cleanroom. It is clear that the ventilator 30 can also be worn at other places of the body or the user, such as at the back or at the belly of the user. It is also clear that alternative coupling systems may be used to couple the ventilator to the body of the user, as long as the ventilator remains stable at the coupling position. Under the cleanroom coverall 10 according to the invention, the user wears standard cleanroom undergarment, like trousers 11 and pants 12.

In the coverall suit 20, at the height of the ventilator 30 worn on the inner side of the coverall suit 20, a coupling means 60 is provided. As shown in FIG. 3, the coupling means 60 couples directly to the ventilator 30. The valve 50 is part of the coupling means 60. In alternative embodiments, the coupling means is coupled to the ventilator not directly but by means of a fluid guiding means, such as a tube. The valve 30 may be located in this fluid guiding means, or at the entrance 31 (or intake side) of the ventilator 30 itself.

Also, for the preferred embodiment shown in FIGS. 1, 2 and 3, the valve 50 may be located in the coupling means 60, at the entrance 31 of the ventilator 30. The valve 50, as shown in the FIGS. 1 to 3 being part of the coupling means 60, has the advantage that upon breaking the coupling between the coupling means 60, (and as it is part of the coverall suit 20, hence the coverall suit 20) and the valve 50, the inner side of the coverall suit 20 remains isolated form the ambient 40. As such, no “dirty” air from inside the coverall suit 20 may flow to the ambient 40, because the valve 50 will close upon breaking of the coupling between valve 30 and coupling means 60.

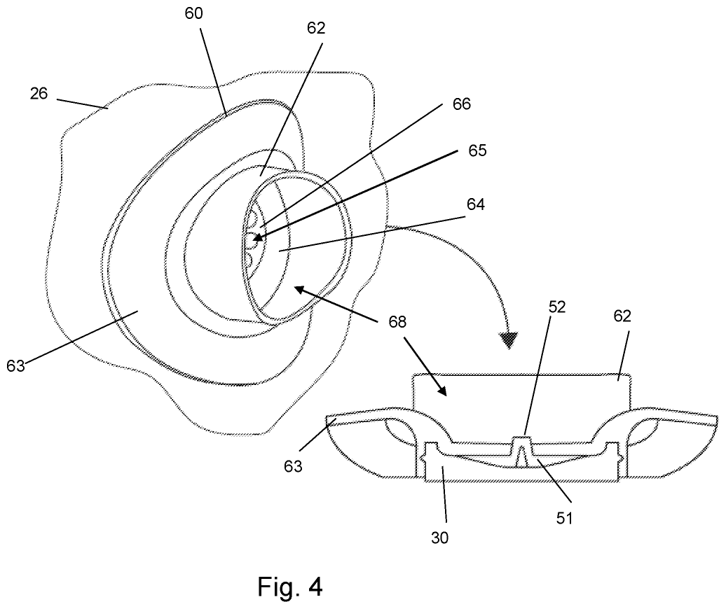

The coupling means 60 and the ventilator 30 may be coupled by a click system, a male portion 61 having projections clicking in recesses of the female portion 32, the latter being part of the housing 33 of the ventilator 30. The coupling may be established by simply pushing the make portion 61 to the female portion 32. It is clear that the provision of male and female portions may be interchanged, as shown in FIG. 4. The user, wearing the ventilator 30 and the coverall suit 20, may use the manipulation means 62, such as simply one or more protrusions, a ring or a bridge part, bridging two opposite sides of the coupling means, to push the coupling means 60 to the ventilator 30.

The ventilator 30 may further comprise a battery 34 and an air moving means 35, such as a fan, to move air taken from the entrance 31 towards the exit opening 36. To the exit opening 36, a tubing system 70, which conducts the air moved by the ventilator 30 to the hood portion 22 of the coverall suit 20. In the hood portion of the coverall suit, an air distributing unit 71, fluidly coupled to the tubes 72 of the tubing system 70, will distribute the air to the head region of the user at the front side of the head of the user. This results in the provision of clean, fresh air to the user, and will reduce the fogging of the goggle 23. The ventilator 30 has preferably a noise emission less than 60 dB. A volume of 50 to 150 l/min may be displaced by the ventilator 30. This allows to the user to work comfortably in his or her own cleanroom coverall, and allows normal communication between two users, each wearing a cleanroom coverall according to the invention.

As shown in FIGS. 1 and 2, the tubing system 70 may comprise tubes 72 which are conducted either at the front side of the body, as shown in FIG. 2, or more preferred, along the backside of the body as shown in FIG. 1. The tubing 72 is preferably provided from polymeric tubes, optionally ribbed and possibly reinforced tubes or hoses. Possibly, electrical conductors are integrated in the wall of the tubes. A CO₂ sensor 81, or any other sensor, may make use of these electrical conductors to communicate with a signal controlling means 80 or an alarm, which alarm may be a part of the signal controlling means 80. The tubes may be held in place by one or more patches 13 provided e.g. on the trouser 11 or pants 12 worn under the cleanroom coverall by the user.

As shown in more detail in FIGS. 3 and 4, the coupling means 60 comprises the one-way valve 50. The coupling means comprises a holding means 63, in this embodiment a holding ring to hold and couple the coupling means 60 to the textile fabric 26 of the coverall suit 20. Typically, the textile fabric material 26 is a relatively dense polyester (PES), filament woven fabric being provided with antistatic properties (by including carbon filaments in warp and weft direction) and having a surface weight of 200 g/m².

The opening 64 of the holding means 63 is provided with a grid-like structure covering the opening as shown in FIG. 3, or as in the embodiment shown in FIG. 4, with cover plate 66 provide with a plurality of apertures 65. The cover plate extends up to the edge of the opening 64. The apertures 65 of the cover plate 66 are closed by the valve body 51, which is held to the backside 67 of the cover plate 66 by means of a resilient means 52. Alternatively, a spring may be provided between the front side 68 of the cover plate 66 and a protruding part 53 of the valve body 51, which extends through and in front of the cover plate 66. Upon coupling of the coupling system 60 to the ventilator 30 and activation of the ventilator 30, the valve body 51 will be pulled towards the entrance 31 of the ventilator 30 due to the under-pressure which will be created at the entrance 31 of the ventilator 30, thus over the two sides of the valve body 51. The resilient means 52 will be compressed at the inflow or frontside 68 and/or stretched at the backside 67, and the valve body will break the contact with the backside 67 of the cover plate 66. As such the apertures 65 will be open and allow air to flow from the ambient 40 towards and into the entrance 31 of the ventilator 30. Upon deactivation of the ventilator 30 or disruption of the coupling of the coupling means 60, the under-pressure will be disrupted over the two sides of the valve body 51. The resilient means 52 will pull the valve body 51 back against the backside 67 of the cover plate 66, hence closing the apertures 65. As such, when the ventilator is not acting on the valve, the valve will be closed and the “dirty” inner side of the coverall suit 10 will not be in communication with the ambient of the cleanroom.

A CO₂ sensor 81 may be provided at the inner side of the coverall suit. Preferably, the CO₂ sensor is an NDIR-based sensor, such as trinamiX PbSe detectors available from trinamiX GmbH, Germany. Preferably, the CO₂ sensor is provided in the upper part of the coverall suit 20, near the chest of the user or near the neck of the user, such as near the upper part of the chest, e.g. near the left or right clavicle of the user or at the level of the thyroid gland of the user. Optionally (not shown) more than one CO₂ sensor may be provided at the inner side of the coverall suit 20. The CO₂ sensor 81 may be communicatively coupled to the ventilator 30, through a communication wire 82 as shown in FIGS. 1 to 4, or wireless. Additional CO₂ sensors or other sensors, such as humidity sensors, temperature sensors, and alike, may be provided and communicatively coupled to the ventilator 30 is a similar way. Communication wires 82 may be kept in place by other or the same patches 13 as used for the tubes 72.

The ventilator 30 may comprise a signal controlling means 80 to which the CO₂- and possibly other sensors are coupled. The measured value of the coupled CO₂ sensor may be used to either switch on or off the ventilator, optionally through the signal controlling means 80, or to control the rotating speed of the fan 35 of the ventilator 30. An alarm 90, optionally integrated in the ventilator 30 and controlled by the signal controlling means 80, may give alarms, e.g. when the ventilator 30 itself is interrupted or broken, when the coupling with the coupling means 60 is interrupted, when the battery 34 is low, or when the measured CO₂ levels are out of the allowed range or an occasional CO₂ peak threshold is exceeded. The alarm may be a visible alarm, although such visible alarm may not always be noticed by the user of the cleanroom coverall. The alarm 90 may hence preferably provide a coded auditive alarm signal or a tactile alarm signal; like a vibration alarm. The code may be indicative for the type of defect noticed. The ventilators air moving means 35, alarm 90, signal controlling means 80, switches, and any other functional element of the ventilator may be in one and the same casing 37 which is coupled to the belt 35 by the hook 36.

The ventilator 30, optionally through a signal controlling means 80, may be in communication with an external controller, which can log the signals of the sensors and which may itself generate alarms and alike. The external controller may trigger the alarm.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1.-15. (canceled)

16. A cleanroom coverall comprising a coverall suit, a ventilator positioned inside said coverall suit, the ventilator being fluidly connected to the ambient of the cleanroom coverall,
wherein between the ambient of the cleanroom coverall and the ventilator, a one-way valve is present, the one-way valve being situated upstream the ventilator, the one-way valve opens when the ventilator is active.

17. The cleanroom coverall according to claim 16, wherein the ventilator is coupled to the coverall suit by means of a coupling means.

18. The cleanroom coverall according to claim 17, wherein the one-way valve is part of the coupling means.

19. The cleanroom coverall according to claim 17, wherein said coupling means couples to the ventilator, optionally via a fluid guiding means, which fluid guiding means is positioned between the coupling means and the intake of the ventilator.

20. The cleanroom coverall according to claim 17, wherein said coupling means comprises a click system.

21. The cleanroom coverall according to claim 16, wherein a CO2 measurement device is present inside the coverall suit.

22. The cleanroom coverall according to claim 21, wherein the CO2 measurement device is communicatively coupled to the ventilator.

23. The cleanroom coverall according to claim 22, wherein the CO2 value measured by the CO2 measurement device is used to control the ventilation and/or ventilation speed of the ventilator.

24. The cleanroom coverall according to claim 21, wherein the cleanroom coverall further comprises an alarm system, generating an alarm signal, such as a visual, tangible and/or auditive signal, when the CO2 value measured by the CO2 measurement device exceeds a threshold value.

25. The cleanroom coverall according to claim 16, wherein the ventilator has a noise output level less than or equal to 80 dB.

26. The cleanroom coverall according to claim 16, wherein the coverall comprises a hood portion, the outlet side of the ventilator is coupled to a tubing system, the tubing system being adapted to bring air to the hood portion of the coverall suit.

27. The cleanroom coverall according to claim 26, wherein the tubing extends into the hood portion of the coverall.

28. The cleanroom coverall according to claim 16, wherein the cleanroom coverall comprises an integrated hood part.

29. The cleanroom coverall according to claim 16, wherein the cleanroom coverall comprises a battery and an alarm system, the alarm system generating an alarm signal, such as a visual, tangible and/or auditive signal, when the battery power goes under a threshold value.

30. The cleanroom coverall according to claim 16, wherein the cleanroom coverall is communicatively coupled to a controller, said controller getting status information on the ventilator, and if applicable the CO2 measurement means and/or the alarm system and/or the battery power.
